(19) United States
(12) Patent Application Publication
(10) Pub. No.: US 2026/0346827 A1
(43) Pub. Date: Nov. 5, 2026

(54) BRAKING SYSTEM FOR AN AIRCRAFT COMPRISING AN ELECTRICALLY ACTUATED DEVICE CONTROLLED BY MEANS OF TWO DIFFERENT MOVEMENTS OF A CONTROL MEMBER

(71) Applicant: SAFRAN LANDING SYSTEMS, Velizy-Villacoublay (FR)

(72) Inventors: David FRANK, Moissy-Cramayel (FR); Jêrôme FRAVAL, Moissy-Cramayel (FR); Steve COUSTENOBLE, Moissy-Cramayel (FR)

(73) Assignee: SAFRAN LANDING SYSTEMS, Velizy-Villacoublay (FR)

(21) Appl. No.: 19/711,604

(22) Filed: Jun. 17, 2026

Related U.S. Application Data
(63) Continuation of application No. PCT/FR2024/051712, filed on Dec. 18, 2024.

(30) Foreign Application Priority Data
Dec. 22, 2023 (FR) 23/15163

(51) Int. Cl. B60T 13/74; B60T 7/08; B60T 7/12; B60T 8/17; B60T 17/22; B64C 25/42

(52) U.S. Cl. CPC B60T 13/745; B60T 7/085; B60T 7/12; B60T 8/1703; B60T 17/22; B64C 25/42

(57) ABSTRACT

A braking system for an aircraft includes at least one electrically actuated device configured to fill at least one cavity of a brake of the aircraft with a hydraulic fluid. The electrically actuated device has a bi-stable operating mode, a progressive operating mode and at least one control member. A first movement of the control member generates a parking order that activates the bi-stable operating mode, and a second movement of the control member generates an emergency braking command that activates the progressive operating mode. At least one direction of the first movement between a return position of the control member and a supply position is different from a direction of the second movement between the return position and the supply position.

### CROSS-REFERENCE TO RELATED APPLICATIONS

This application is a continuation of International Application No. PCT/FR 2024/051712, filed on Dec. 18, 2024, which claims priority to and the benefit of French Patent Application No. FR 2315163 filed on Dec. 22, 2023. The disclosures of the above applications are incorporated herein by reference.

### FIELD

The present disclosure relates to the field of aircraft and more particularly to a braking system and a braking method for an aircraft.

### BACKGROUND

The statements in this section merely provide background information related to the present disclosure and may not constitute prior art.

A braking system of an aircraft must include a normal braking system, an emergency braking system to supplement the normal braking system in the event of an issue, and a parking braking system making it possible to keep the aircraft stationary.

The emergency braking system must allow for a brake pressure level that is variable according to a pilot command.

The parking braking system must make it possible to maintain the brake pressure level when the aircraft is stationary and during aircraft shutdown.

A hydromechanical form exists that provides a set of members forming part of both the emergency braking system and the parking braking system. This form has drawbacks such as: difficulty of installation, the need for a cable to extend from the aircraft cockpit to a main landing gear bay, the inability to monitor potential issues during operation of the aircraft (jamming or breakage of a cable element), the desire to perform regular maintenance operations (monitoring, lubrication of the cable sheath, etc.), the significant weight of the cable system and its fasteners. There is also an electrically actuated form described in document FR3082503 in which the emergency braking system is at least partially combined with the parking braking system. In this form, a valve provides both progressive emergency braking and on/off parking braking. The valve is controlled by an action on a control lever equipped with a device capable of delivering a voltage proportional to its position. Pulse width modulation (PWM) control makes it possible to transform this valve into a proportional valve.

The drawback of this is that it actuates the parking braking after a more or less prolonged period of emergency braking activation.

### SUMMARY

This section provides a general summary of the disclosure and is not a comprehensive disclosure of its full scope or all of its features.

One form relates to a braking system for an aircraft comprising at least one electrically actuated device configured to fill at least one cavity of an aircraft brake with a hydraulic fluid, the electrically actuated device having, on the one hand, a bistable operating mode in which the hydraulic fluid of the at least one cavity of the brake is maintained at a return pressure or at a supply pressure, and on the other hand, a progressive operating mode in which the pressure of the hydraulic fluid of the at least one cavity of the brake is between the return pressure and the supply pressure, and at least one control member of the electrically actuated device, characterized in that a first movement of the control member generates a parking command that activates the bistable operating mode, and a second movement of the control member generates an emergency braking command that activates the progressive operating mode, at least one sense of the first movement between a return position of the control member, corresponding to a command to maintain the hydraulic fluid of the at least one cavity of the brake at the return pressure, and a supply position, corresponding to a command to maintain the hydraulic fluid of the at least one cavity of the brake at the supply pressure, being different from a sense of the second movement between the return position and the supply position.

The electrically actuated device makes it possible to fill the at least one cavity of the aircraft brake with a hydraulic fluid so as to vary a pressure of the hydraulic fluid at the brakes between a return pressure corresponding to no braking, and a supply pressure corresponding to maximum braking.

The electrically actuated device may comprise a valve in which a spool of the valve connects an outlet port leading to the at least one cavity of the brake to: a return port making it possible to decrease the pressure of the hydraulic fluid, the spool is then defined as being in a passive state, or to a supply port making it possible to increase the pressure of the hydraulic fluid, the spool is then defined as being in an active state.

The electrically actuated device may further comprise an electric actuator, such as an electric coil or an electric motor, making it possible to change the state of the spool.

The electrically actuated device may also comprise a return spring making it possible to return the spool to the passive state when the electric actuator is no longer powered.

The electrically actuated device can operate, depending on the received command, in two modes: the bistable operating mode, that is to say on/off. In this operating mode, the electrically actuated device makes it possible to bring the pressure of the hydraulic fluid at the brake to either the return pressure or the supply pressure. The bistable operating mode is activated by a parking command. In the progressive operating mode, in which the pressure of the hydraulic fluid at the brake is between the return pressure and the supply pressure, the pressure of the hydraulic fluid at the brake depends on the second movement applied by a pilot to the control member. The progressive operating mode is activated by an emergency braking command.

The progressive operating mode can be obtained by a PWM control.

For example, the electrically actuated device can be of the type described in document FR3 082 503.

The control member can be a physical member, for example, one that can be held manually by the aircraft pilot. The control member can be positioned in the aircraft cockpit so as to be accessible to the pilot. The control member can be of any type such as: a lever, a trigger, or a rotary knob.

A movement of the control member corresponds to the successive positions taken by the control member in space over time.

The control member can be positioned in at least one return position in which the control member sends a command to the electrically actuated device to bring the pressure of the hydraulic fluid at the brake to the return pressure.

The control member can be positioned in at least one supply position in which the control member sends a command to the electrically actuated device to bring the pressure of the hydraulic fluid at the brake to the supply pressure.

The movement of the control member is in particular defined by: a direction of movement that corresponds to a curve formed by the set of successive positions, and a sense of movement that corresponds to the orientation of the curve formed by the set of successive positions.

In this case, the sense of the first movement and the second movement is defined from the return position to the supply position. In other words, the return position corresponds to an upstream position of the movement, and the supply position corresponds to a downstream position of the movement of the control member, the sense of movement being defined from upstream to downstream.

When the control member is actuated according to the first movement, a parking command is sent to the electrically actuated device. The parking command activates the bistable operating mode, thereby bringing the hydraulic fluid to either the supply pressure or the return pressure.

When the control member is actuated according to the second movement, an emergency braking command is sent to the electrically actuated device. The emergency braking command activates the progressive operating mode, thereby bringing the hydraulic fluid to a variable value between the supply pressure and the return pressure.

According to some variations, the return positions of the first movement and the second movement coincide.

According to some variations, the return position of the first movement is distinct from the return position of the second movement.

According to some variations, the supply position of the first movement is distinct from the supply position of the second movement.

According to some variations, the control member can be positioned in a rest position in which neither of the operating modes of the electrically actuated device is actuated. In other words, in the rest position, the electrically actuated device is not activated.

According to some variations, the rest position and the return positions of the first movement and the second movement of the control member coincide.

According to some variations, the direction of the first movement and/or the second movement is rectilinear.

According to some variations, the direction of the first movement and/or the second movement is circular.

Thus, it is possible to distinguish a movement, relative to a reference frame in which the control member is in a position of use, that has a rectilinear direction and a forward, backward, right, left, up, or down sense. It is also possible to distinguish a movement, relative to the reference frame in which the control member is in the position of use, that has a circular direction and a clockwise or counterclockwise sense of rotation.

According to the present disclosure, the control member can be actuated according to the first movement and according to the second movement, the first movement having at least one sense different from the sense of the second movement. In other words, the first movement and the second movement can have the same direction, but they differ at least in the sense of moving from the return position to the supply position.

Thus, the movement associated with the bistable operating mode, and the generated parking command, is different from the movement associated with the progressive operating mode, and the generated emergency braking command. More specifically, the braking system according to the present disclosure separates the movement from the generated commands making it possible to control each of the two operating modes. Therefore, there is no risk of triggering the progressive operating mode before using the bistable operating mode, and vice versa. The control of the braking system is therefore more reliable.

The present disclosure may also have one or more of the following features, taken alone or in combination.

In some forms, the sense of the first movement is opposite to the sense of the second movement.

Thus, the direction of movement may be the same, for example, rectilinear or circular, but the sense of the two movements is opposite. In other words, a movement in a first sense of the control member generates the parking command which actuates the bistable operating mode, whereas in a second sense, opposite to the first sense, the control member generates the emergency braking command which actuates the progressive operating mode.

For example, the control member pushed upwards relative to the reference frame in which the control member is in the position of use will generate the parking command and actuate the bistable operating mode, whereas the control member pushed downwards relative to the reference frame in which the control member is in the position of use will generate the emergency braking command and actuate the progressive operating mode.

In some forms, the first movement and the second movement are selected from: a rectilinear movement, a circular movement.

The direction of the movement is therefore rectilinear or circular.

In some forms, the control member comprises a measuring sensor configured to detect a position or a force applied to the control member.

In some variations, the measuring sensor detects the position or the force applied to the control member, in particular during the second movement.

Thus, the control member, by means of the measuring sensor, can generate and transmit the emergency braking command, which depends on the position or the force applied to the control member.

The dependence can be a proportional relationship between a value of the emergency braking command and the position or the force of the control member.

The pilot can therefore easily vary the progressive braking by changing, to a greater or lesser extent, the position of, or the force applied to the control member.

In some variations, the braking system also comprises at least one activation device configured to energize the electrically actuated device.

The activation device is a safety device ensuring that a simple failure of the braking system does not result in unintended braking.

To this end, the activation device comprises an activated state in which the electrically actuated device is energized and a deactivated state in which the electrically actuated device is de-energized (partially or totally).

When the electrically actuated device is energized, the electrically actuated device can change the pressure of the hydraulic fluid according to the received parking command or emergency braking command.

When the electrically actuated device is de-energized (partially or totally), the electrically actuated device cannot be controlled. In other words, the electrically actuated device cannot change the pressure of the hydraulic fluid according to the received parking command or emergency braking command.

In some variations, the at least one activation device is positioned on the control member.

In some variations, the at least one activation device is a trigger or a knob.

In some variations, the at least one activation device functions as an electrical switch.

Thus, when the activation device is activated, that is to say brought into the activated state, it energizes the electrically actuated device. When the activation device is deactivated, that is to say brought into the deactivated state, it de-energizes all or part of the electrically actuated device.

For example, the activated state is obtained by a pressure applied to the activation device, whereas the deactivated state is the state of the activation device when no force is applied to the activation device.

In some variations, the at least one activation device is configured to generate an activation command making it possible to control an electrical switch.

The at least one activation device then generates an activation command that actuates an electrical switch, the electrical switch allowing the (total or partial) energization of the electrically actuated device.

In some variations, the at least one activation device is implemented by a flight computer.

The flight computer generates a (total or partial) energization or de-energization of the electrically actuated device according to, for example, an aircraft operating phase or a pilot request.

In some variations, the braking system also comprises at least one mechanical or electromagnetic locking device configured to inhibit the movement of the control member.

The mechanical or electromagnetic locking device can inhibit the first movement and/or the second movement of the control member.

The mechanical or electromagnetic locking device can hold the control member in its position.

The mechanical or electromagnetic locking device comprises a locked state in which a position of the control member cannot be changed. Preferably, in the locked state, the mechanical or electromagnetic locking device locks the control member in the rest position.

The mechanical or electromagnetic locking device comprises an unlocked state in which a position of the control member can be changed so as to generate a parking command or an emergency braking command to activate one of the operating modes of the electrically actuated device.

In some variations, the activation device and the mechanical or electromagnetic locking device are combined, that is to say, an action on the activation device also brings the mechanical or electromagnetic locking device into the unlocked state.

Another aspect of the present disclosure relates to a braking method for an aircraft comprising a braking system according to the present disclosure, implementing: A step of controlling a parking braking in which a pilot actuates the control member according to the second movement; A step of controlling an emergency braking in which the pilot actuates the control member according to the first movement.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of a braking system according to the present disclosure;

FIG. 2 is a schematic representation of an activation device according to a first variation;

FIG. 3 is a schematic representation of an activation device according to a second variation.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Only the elements necessary for understanding the present disclosure have been represented. To facilitate reading the drawings, the same elements are designated by the same reference numerals from one figure to another.

It should be noted that in this document, the terms “forward,” “backward,” “right,” “left,” “up,” “down,” used to describe a sense of movement of the control member refer to the movement of the control member in a position of use relative to an aircraft pilot.

The present disclosure relates to a braking system 1 for an aircraft.

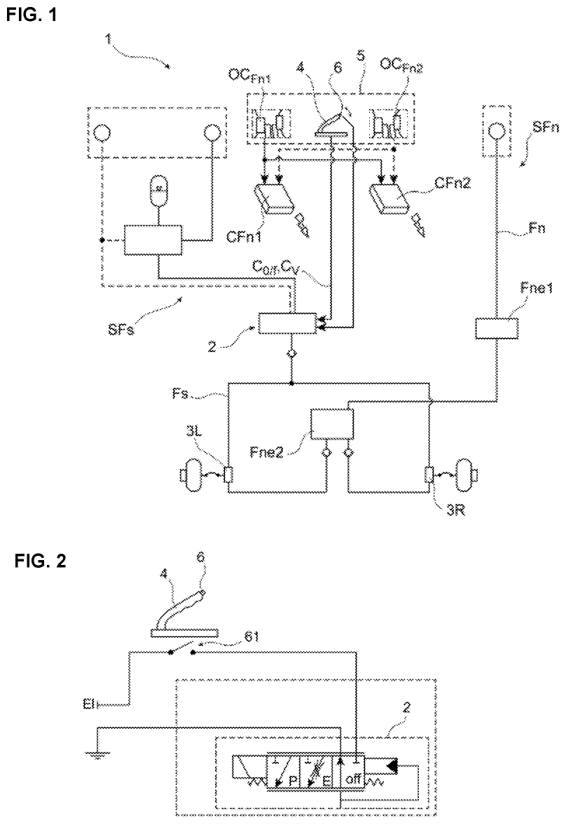

In FIG. 1, the aircraft comprises two wheels L, R, each connected to a brake cavity 3R, 3L. During braking, these cavities 3L, 3R are filled with a hydraulic fluid Fn, Fs.

When a pressure of the hydraulic fluid Fn, Fs at the cavities 3L, 3R of the brakes is equal to a return pressure, no braking occurs, in other words 0% braking.

When a pressure of the hydraulic fluid Fn, Fs at the cavities 3L, 3R of the brakes is equal to a supply pressure, maximum braking occurs, in other words 100% braking.

When a pressure of the hydraulic fluid Fn, Fs at the cavities 3L, 3R of the brakes is between the supply pressure and the return pressure, braking at a variable level occurs, in other words braking that varies between 0% and 100%.

The braking system 1 comprises a normal braking subsystem designed to provide braking at a variable level, that is to say between 0% and 100%. To this end, the normal braking subsystem comprises a normal control portion that generates a command intended to drive a normal hydraulic portion, the normal hydraulic portion SFn varying the pressure of the hydraulic fluid Fn between 0% and 100%. The normal control portion comprises at least one first controller OC_{Fn1} that generates a command transmitted by a first computer CFn1 to the normal hydraulic portion. Redundantly, in the event of an issue with the first controller OC_{Fn1} and/or the first computer CFn1, the normal control portion also comprises an emergency controller OC_{Fn2} that can generate a command that will be transmitted by an emergency computer CFn2 to the normal hydraulic portion.

The normal hydraulic portion comprises a plurality of elements Fne1, Fne2, making it possible to vary the pressure of the hydraulic fluid Fn at the cavities 3L, 3R of the brakes between the supply pressure and the return pressure.

There are many ways to implement the normal braking subsystem, the described elements are just one example.

The braking system 1 also comprises an emergency and parking braking subsystem that is designed to provide, on the one hand, emergency braking at a variable level, and on the other hand, parking braking at the supply pressure.

To this end, the emergency and parking braking subsystem comprises, in particular, an emergency hydraulic portion SFs that is provided with an electrically actuated device 2.

The electrically actuated device 2 may comprise a valve in which a spool of the valve connects an outlet port of the emergency hydraulic portion SFs leading to the at least one cavity 3L, 3R of the brake to: a return port of the emergency hydraulic portion SFs, making it possible to decrease the pressure of the hydraulic fluid Fs, the spool is then defined as being in a passive state, or to a supply port of the emergency hydraulic portion SFs, making it possible to increase the pressure of the hydraulic fluid Fs, the spool is then defined as being in an active state.

The electrically actuated device 2 may further comprise an electric actuator, such as an electric coil or an electric motor, making it possible to change the state of the spool.

The electrically actuated device 2 may also comprise a return spring making it possible to return the spool to the passive state when the electric actuator is no longer powered.

The electrically actuated device 2 can operate in two modes: a bistable operating mode, that is to say on/off. In this operating mode, the electrically actuated device 2 makes it possible to bring the pressure of the hydraulic fluid Fs at the cavity 3R, 3L of the brake to either the return pressure or the supply pressure. The bistable operating mode is activated by a parking command C_{o/f}; a progressive operating mode in which the pressure of the hydraulic fluid Fs at the cavity 3R, 3L of the brake is between the return pressure and the supply pressure. The progressive operating mode is activated by an emergency braking command Cᵥ.

The progressive operating mode can be obtained by a PWM control.

For example, the electrically actuated device 2 may be of the type described in document FR3 082 503.

The emergency and parking braking subsystem also comprises at least one control member 4 of the electrically actuated device 2.

The control member 4 may be a physical member as illustrated in FIG. 1, for example, one that can be held manually by an aircraft pilot. The control member 4 may be positioned in a cockpit 5 of the aircraft so as to be accessible to the pilot. The control member 4 may be of any type, such as: a lever, a trigger, or a rotary knob.

A movement of the control member 4 corresponds to the successive positions taken by the control member in space over time.

The control member 4 may be positioned in at least one return position in which the control member 4 sends a command to the electrically actuated device 2 to bring the pressure of the hydraulic fluid Fs at the brake to the return pressure. In other words, the return position of the control member 4 corresponds to a command to maintain the hydraulic fluid Fs of the at least one cavity 3L, 3R of the brake at the return pressure.

The control member 4 can be positioned in at least one supply position in which the control member 4 sends a command to the electrically actuated device 2 to bring the pressure of the hydraulic fluid Fs at the brake to the supply pressure.

In other words, the supply position corresponds to a command to maintain the hydraulic fluid Fs of the at least one cavity 3L, 3R of the brake at the supply pressure.

Finally, the control member 4 can be positioned in a rest position in which no command is sent to the electrically actuated device 2. In other words, when the control member 4 is in the rest position, none of the operating modes of the electrically actuated device 4 are activated.

The movement of the control member 4 is defined in particular by: a direction of movement that corresponds to a curve formed by the set of successive positions, and a sense of movement that corresponds to an orientation of the curve formed by the set of successive positions.

According to the present disclosure, the control member 4 can be actuated according to a first movement and according to a second movement, the first movement having at least one sense different from the sense of the second movement. In other words, the first movement and the second movement may have the same direction, but they differ at least in the sense of moving from the return position to the supply position. In this case, the sense of the first movement and the second movement is defined from the return position to the supply position. In other words, the return position corresponds to an upstream position of the movement and the supply position corresponds to a downstream position of the movement of the control member 4, the sense of movement being defined from upstream to downstream.

According to the present disclosure, the first movement of the control member 4 generates a parking command C_{o/f} which activates the bistable operating mode, and the second movement of the control member 4 generates an emergency braking command Cᵥ, which activates the progressive operating mode, at least one sense of the first movement between the return position and the supply position being different from one sense of the second movement between the return position and the supply position.

When the control member 4 is actuated according to the first movement, the parking command C_{o/f} is sent to the electrically actuated device 2. The parking command C_{o/f} activates the bistable operating mode, thereby bringing the hydraulic fluid Fs to the supply pressure or to the return pressure.

When the control member 4 is actuated according to the second movement, the emergency braking command Cᵥ is sent to the electrically actuated device 2. The emergency braking command Cᵥ activates the progressive operating mode, thereby bringing the hydraulic fluid Fs to a variable value between the supply pressure and the return pressure.

Thus, the movement and the parking command C_{o/f} associated with the bistable operating mode is different from the movement and the emergency braking command Cᵥ associated with the progressive operating mode. More specifically, the braking system 1 according to the present disclosure separates the movement and the commands making it possible to control each of the two operating modes.

Therefore, there is no risk of triggering the progressive operating mode before using the bistable operating mode, and vice versa. The control of the braking system is therefore more reliable.

According to some variations, the return positions of the first movement and the second movement coincide.

According to some variations, the return position of the first movement is distinct from the return position of the second movement.

According to some variations, the supply position of the first movement is distinct from the supply position of the second movement.

According to some variations, the rest position and the return positions of the first movement and the second movement of the control member 4 coincide.

Thus, it is possible to distinguish a movement, relative to a reference frame in which the control member 4 is in a position of use, that has a rectilinear direction and a forward, backward, right, left, up, or down sense. It is also possible to distinguish a movement, relative to the reference frame in which the control member 4 is in the position of use, that has a circular direction and a clockwise or counterclockwise sense of rotation.

In some variations, the first movement and the second movement are selected from: a rectilinear movement, a circular movement.

The direction of the movement is therefore rectilinear or circular.

In some variations, the control member 4 comprises a measuring sensor configured to detect a position or a force applied to the control member 4.

In some variations, the measuring sensor detects the position or the force applied to the control member 4, in particular during the second movement.

Thus, the control member 4, by means of the measuring sensor, can generate and transmit the emergency braking command Cᵥ which depends on the position or the force applied to the control member 4.

The dependence can be a proportional or multi-slope relationship between a value of the emergency braking command Cᵥ and the position or the force of the control member 4.

The pilot can therefore easily vary the progressive braking by changing, to a greater or lesser extent, the position of, or the force applied to, the control member 4.

According to some variations, the direction of the first movement and/or the second movement is rectilinear.

According to some variations, the direction of the first movement and/or the second movement is circular.

In some variations, the sense of the first movement is opposite to the sense of the second movement.

Thus, the direction of movement can be the same, for example, rectilinear or circular, but the sense of the two movements is opposite. In other words, a movement in the first sense of the control member generates the parking command Co/f that actuates the bistable operating mode, whereas in a second sense, opposite to the first sense, the control member generates the emergency braking command Cᵥ that actuates the progressive operating mode.

For example, and as illustrated in FIG. 1, when the control member 4 is pulled upwards, the control member generates the emergency braking command Cᵥ varying between 0% and 100%, which activates the progressive operating mode and therefore emergency braking. When the control member 4 is pushed downwards, the control member 4 generates the parking command C_{o/f} varying over a range between 0% and −10%, any parking command C_{o/f} between −10% and −5% will then be interpreted as a request to activate the parking brake, that is to say, bringing the hydraulic fluid Fs to the supply pressure, whereas any parking command Co/f between −5% and 0% will then be interpreted as a request to deactivate the parking brake, that is to say, bringing the hydraulic fluid Fs to the return pressure.

In some variations, the braking system 1 also comprises at least one activation device 6 configured to energize or de-energize the electrically actuated device 2.

The activation device 6 is a safety device ensuring that a simple failure of the braking system does not result in unintended braking.

To this end, the activation device 6 comprises an activated state in which the electrically actuated device 2 is energized and a deactivated state in which the electrically actuated device 2 is de-energized.

When the electrically actuated device 2 is energized, the electrically actuated device 2 can change the pressure of the hydraulic fluid Fs according to the received parking command C_{o/f} or emergency braking command Cᵥ.

When the electrically actuated device 2 is de-energized, the electrically actuated device cannot be controlled. In other words, the electrically actuated device 2 cannot change the pressure of the hydraulic fluid Fs according to the received parking command C_{o/f} or emergency braking command Cᵥ.

In some variations, the at least one activation device 6 is positioned on the control member 4.

In some variations, the at least one activation device 6 is a trigger, or a knob.

In some variations, the at least one activation device 6 functions as an electrical switch 61, as illustrated in FIG. 2.

Thus, when the activation device 6 is activated, that is to say brought into the activated state, it energizes the electrically actuated device 2, that is to say, it connects a power supply EI to the electrically actuated device 2.

When the activation device 6 is deactivated, that is to say brought into the deactivated state, it de-energizes the electrically actuated device 2, that is to say, it breaks the connection between the power supply EI and the electrically actuated device 2.

For example, the activated state is obtained by a pressure applied to the activation device 6, whereas the deactivated state is the state of the activation device 6 when no force is applied to the activation device 6 or following successive presses.

In some variations, the at least one activation device 6 is configured to generate an activation command Cₐ making it possible to control an electrical switch

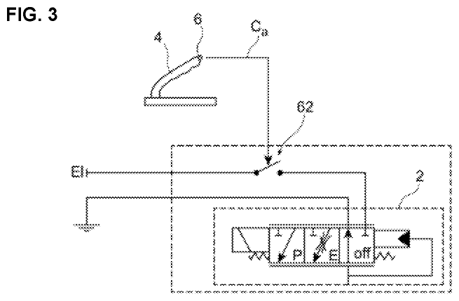

### 62, As Illustrated in FIG. 3.

The at least one activation device 6 then generates an activation command Cₐ that actuates an electrical switch 62, the electrical switch 62 allowing energization of the electrically actuated device 2, that is to say connecting it to the power supply El.

In some variations, the at least one activation device 6 is implemented by a flight computer.

The flight computer generates a (total or partial) energization or de-energization of the electrically actuated device 2 according to, for example, an aircraft operating phase or a pilot request.

In some variations, the braking system also comprises at least one mechanical or electromagnetic locking device configured to inhibit the movement of the control member 4.

The mechanical or electromagnetic locking device can inhibit the first movement and/or the second movement of the control member 4.

The mechanical or electromagnetic locking device can hold the control member 4 in its position.

The mechanical or electromagnetic locking device comprises a locked state in which a position of the control member 4 cannot be changed. Preferably, in the locked state, the mechanical or electromagnetic locking device locks the control member 4 in the rest position.

The mechanical or electromagnetic locking device comprises an unlocked state in which a position of the control member 4 can be changed so as to activate one of the operating modes of the electrically actuated device 2.

In some variations, the activation device 6 and the mechanical or electromagnetic locking device are combined, that is to say, an action on the activation device 6 also brings the mechanical or electromagnetic locking device into the unlocked state.

Another aspect of the present disclosure relates to a braking method for an aircraft comprising a braking system 1 according to the present disclosure, implementing: Controlling a parking braking in which a pilot actuates the control member 4 according to the second movement; Controlling an emergency braking in which the pilot actuates the control member 4 according to the first movement.

Although the present disclosure has been described with reference to specific variations, it is evident that modifications and changes can be made to these examples without departing from the general scope of the present disclosure as defined by the claims. In particular, individual features of the various illustrated/mentioned variations can be combined in additional forms. Therefore, the description and the drawings should be considered in an illustrative rather than a restrictive sense.

It is also evident that all the features described with reference to a method are transposable, alone or in combination, to a device, and conversely, all the features described with reference to a device are transposable, alone or in combination, to a method.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A braking system for an aircraft, comprising:
at least one electrically actuated device configured to fill at least one cavity of an aircraft brake with a hydraulic fluid, the at least one electrically actuated device having a bistable operating mode in which the hydraulic fluid of the at least one cavity of the aircraft brake is maintained at a return pressure or a supply pressure, and a progressive operating mode in which a pressure of the hydraulic fluid of the at least one cavity of the aircraft brake is between the return pressure and the supply pressure; and
at least one control member associated with the at least one electrically actuated device,
wherein a first movement of the at least one control member is configured to generate a parking command that activates the bistable operating mode and a second movement of the at least one control member is configured to generate an emergency braking command that activates the progressive operating mode, the first movement between a return position of the at least one control member, corresponding to a command to maintain the hydraulic fluid of the at least one cavity of the aircraft brake at the return pressure, and a supply position, corresponding to a command to maintain the hydraulic fluid of the at least one cavity of the aircraft brake at the supply pressure, is different from the second movement between the return position and the supply position.

2. The braking system according to claim 1, wherein the first movement is opposite the second movement.

3. The braking system according to claim 1, wherein the first movement and the second movement are selected from a rectilinear movement or a circular movement.

4. The braking system according to claim 1, wherein the at least one control member comprises a measuring sensor configured to detect a position or a force applied to the at least one control member.

5. The braking system according to claim 1, further comprising at least one activation device configured to energize the at least one electrically actuated device.

6. The braking system according to claim 5, wherein the at least one activation device functions as an electrical switch.

7. The braking system according to claim 5, wherein the at least one activation device is configured to generate an activation command to control an electrical switch.

8. The braking system according to claim 5, wherein the at least one activation device is implemented by a flight computer.

9. The braking system according to claim 1, further comprising at least one mechanical locking device or at least one electromagnetic locking device configured to inhibit a movement of the at least one control member.

10. A braking method for an aircraft including the braking system according to claim 1, the method comprising:
controlling a parking braking in which a pilot actuates the at least one control member according to the second movement;
controlling an emergency braking in which the pilot actuates the at least one control member according to the first movement.
